(19) United States
(12) Patent Application Publication
(10) Pub. No.: US 2018/0272767 A1
(43) Pub. Date: Sep. 27, 2018

(54) PAPER CONVEYANCE DEVICE, AND PRINTER

(71) Applicant: SEIKO EPSON CORPORATION, TOKYO (JP)

(72) Inventor: Masahiro KAWAJIRI, Shiojiri-shi (JP)

(73) Assignee: SEIKO EPSON CORPORATION, TOKYO (JP)

(21) Appl. No.: 15/926,650

(22) Filed: Mar. 20, 2018

(30) Foreign Application Priority Data
Mar. 22, 2017 (JP) 2017-055807

(51) Int. Cl. B41J 15/04; B65H 16/10; B65H 16/06; B41J 15/08

(52) U.S. Cl. CPC B41J 15/048; B65H 16/10; B65H 16/06; B65H 2301/413683; B41J 15/042; B41J 15/08; B65H 2301/12; B41J 15/046

(57) ABSTRACT

A paper compartment in which roll paper can be held has an opening positioned along the second axial end of the roll paper and a wall positioned along the first axial end of the roll paper in the axial direction. The paper loading member can be removably installed in the paper compartment through the opening. The paper loading member has a flange and a roll support member that projects from the flange and is inserted into the paper. When roll paper is held in the paper compartment, the paper loading member is installed in the paper compartment with a first side of the flange contacting the first axial end of the paper, and the roll support member is inserted into the roll paper. When the paper loading member is installed in the paper compartment, the first side of the flange faces the opening.

### CROSS-REFERENCE TO RELATED PATENT APPLICATIONS

This application claims priority and the benefit of Japan Priority Application 2017-055807, filed Mar. 22, 2017, the entire disclosure of which is incorporated herein by reference in its entirety.

### FIELD

The present disclosure relates generally to a paper conveyance device and a printer.

### BACKGROUND

Paper conveyance devices (continuous sheet roll holding devices) that store roll paper (a continuous sheet wound into a roll) are known from the literature. See, for example, JP-A-2011-230865.

With devices that store paper in a roll such as the paper conveyance device described above, there is a need to simplify loading the paper and improve user convenience. This need is also confronted in printing devices that have a printing function and are configured to print on stored roll paper.

### SUMMARY

Some embodiment disclosed herein are directed to this above-mentioned need, providing a paper conveyance device and printer that simplify loading or installing roll paper.

A paper conveyance device according to one embodiment has a paper compartment and a paper loading member. The paper compartment is configured to hold roll paper that extends between a first axial end and a second axial end. The paper compartment has an opening positioned along the second axial end of the roll paper when the roll paper is held in the paper compartment. The paper loading member is configured to be removably installed in the paper compartment through the opening. The paper loading member includes a flange and a roll support member that protrudes from the flange and is configured to be inserted into the core of the paper. When the roll paper is held in the paper compartment, the paper loading member is installed in the paper compartment with a first side of the flange contacting the first axial end of the roll paper, and the roll support member is inserted into the core of the roll paper. When the paper loading member is installed in the paper compartment, the first side of the flange of the paper loading member is the side of the flange that faces the opening of the paper compartment.

This configuration enables installing paper in the paper compartment by the simple process of inserting the roll support member of the paper loading member in the paper so that one side of the paper roll contacts one side of the flange, and then loading the paper loading member through the opening to the paper compartment.

In a paper conveyance device according to another embodiment, the length of the roll support member is greater than the maximum width of the roll paper held in the paper compartment.

This configuration can stabilize the paper with the roll support member.

In a paper conveyance device according to another embodiment, the roll support member has a through-hole passing lengthwise through the roll support member, the paper compartment has a roll spindle extending along the axial direction of the roll paper held in the paper compartment, and the roll spindle is inserted into the through-hole of the roll support member when the paper loading member is installed in the paper compartment.

This configuration enables installing the paper loading member to the paper compartment by the simple task of inserting the roll spindle to the through-hole in the roll support member.

In a paper conveyance device according to another embodiment, the length of the roll spindle is greater than the length of the roll support member, and when the paper loading member is installed in the paper compartment, the an opening-side end of the roll spindle of the paper compartment is closer to the opening of the paper compartment than an opening-side end of the roll support member of the paper loading member.

This configuration can stabilize the roll support member by the roll spindle.

In a paper conveyance device according to another embodiment, the roll spindle has a marking indicating a position of the opening-side end of the roll support member.

This configuration enables the user to use the marking on the roll spindle to easily confirm the position of the roll support member on the roll spindle.

A paper conveyance device according to another embodiment preferably also has a roll support member stop that is configured to be installed on the roll spindle to which the paper loading member is installed and restrict the position of the roll support member on the roll spindle.

This configuration enables appropriately positioning the roll support member to the roll spindle by the roll support member stop.

A paper conveyance device according to another embodiment preferably also has a paper stop that is configured to be installed to the roll support member when the first axial end of the roll paper is in contact with the one side of the flange and the roll support member is inserted into the core of the roll paper, contact the second axial end of the roll paper installed on the roll support member, and restrict the position of the roll paper on the roll support member.

This configuration enables appropriately restricting the position of the paper on the roll support member with the paper stop.

A paper conveyance device according to another embodiment has an arrangement where the paper compartment has a wall positioned closer to the first axial end of the roll paper than the second axial end of the roll paper when the roll paper is held in the paper compartment.

A paper conveyance device according to another embodiment has an arrangement where, when the paper loading member is installed in the paper compartment, a second side of the flange contacts the wall. The second side of the flange faces the wall of the paper compartment.

Another embodiment is a printing device that includes a paper compartment, a printing mechanism, and a paper loading member. The paper compartment is configured to hold roll paper that extends between a first axial end and a second axial end. The paper compartment has an opening positioned along the second axial end of the roll paper when the roll paper is held in the paper compartment and a wall positioned along the first axial end of the roll paper when the roll paper is held in the paper compartment. The printing mechanism is configured to print on the roll paper. The paper loading member is configured to be removably installed in the paper compartment through the opening. The paper loading member includes a flange and a roll support member that protrudes from the flange and is configured to be inserted into the core of the paper. When the roll paper is held in the paper compartment, the paper loading member is installed in the paper compartment with a first side of the flange contacting the first axial end of the roll paper, and the roll support member is inserted into the roll paper. When the paper loading member is installed in the paper compartment, the first side of the flange of the paper loading member is the side of the flange that faces the opening of the paper loading member.

This configuration enables installing paper in the paper compartment by the simple process of inserting the roll support member of the paper loading member to the paper so that one side of the paper roll contacts one side of the flange, and then installing the paper loading member through the opening to the paper compartment.

Other features with a fuller understanding of the invention, will become apparent and appreciated by referring to the following description and claims taken in conjunction with the accompanying drawings.

### BRIEF DESCRIPTION OF THE DRAWINGS

FIG. 1 illustrates the configuration of main parts of a printer.

FIG. 2 illustrates the paper compartment.

FIG. 3 shows the paper compartment when the paper loading member is installed in the paper compartment.

FIG. 4 illustrates the paper loading member.

FIG. 5 illustrates installing a paper roll on the paper loading member.

FIG. 6 illustrates installing the paper stop to the roll support member.

FIG. 7 illustrates installing the paper loading member to the paper compartment.

### DESCRIPTION OF EMBODIMENTS

Various embodiment are described below with reference to the accompanying figures.

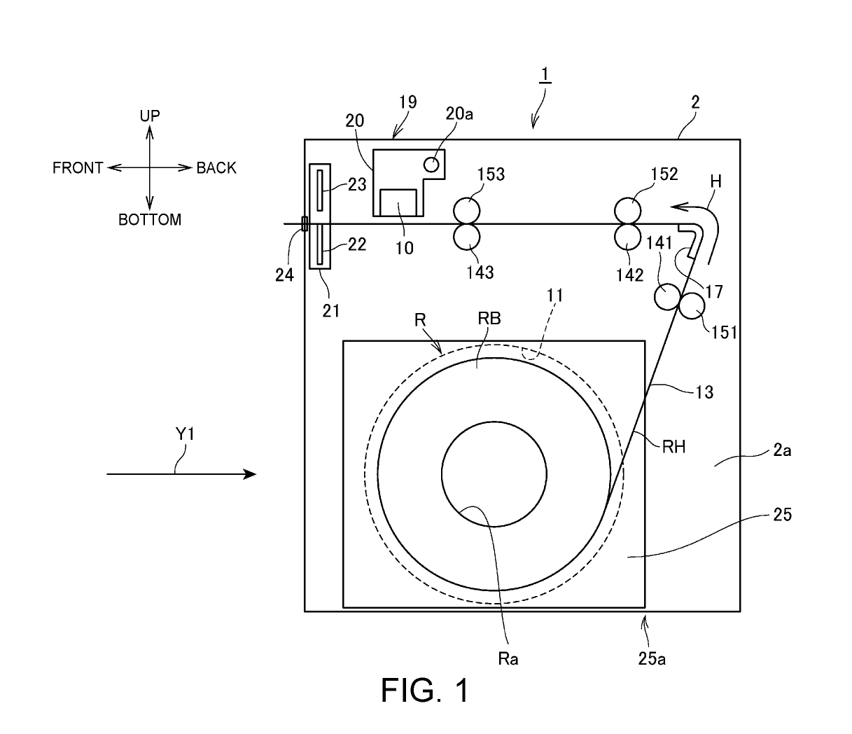

FIG. 1 illustrates the configuration of main parts of a printer 1 (which may be, for example, a paper conveyance device or a printing device) according to a preferred embodiment.

As indicated by the arrows in FIG. 1, the direction to the left side of the figure is to the front of the printer 1 and the direction to the right side of the figure is to the back, the direction to the top side of the figure is to the top of the printer 1 and the direction to the bottom side of the figure is to the bottom.

The printer 1 in this example is a serial inkjet printer. The printer 1 stores roll paper R (paper wound into a roll), and delivers and conveys the roll paper R from the paper roll in the conveyance direction H. The printer 1 prints by ejecting ink onto the conveyed roll paper R from an inkjet head 10, which in this example is a serial inkjet head.

In this example, the printer 1 is a device that holds paper having multiple labels affixed at a regular interval to a continuous backing sheet R2 as the roll paper R, and continuously prints images on the labels. In another example, the printer 1 may be a large format printer (LFP).

As shown in FIG. 1, the printer 1 has a case 2. Inside the case 2 is a paper compartment 11 that is configured to hold the roll paper R. The paper compartment 11 is described in detail below. Herein, the portion of the roll paper R that is stored in a roll in the paper compartment 11 is referred to as the paper roll RB. The portion of the roll paper R that is delivered and conveyed from the paper roll RB stored in the paper compartment 11 is referred to as the conveyed roll paper RH.

As shown in FIG. 1, a conveyance path 13, which is the path through which the conveyed roll paper RH is conveyed, is formed inside the printer 1. The conveyed roll paper RH delivered from the paper roll RB is conveyed in the conveyance direction H through the conveyance path 13.

As shown in FIG. 1, disposed to the conveyance path 13 sequentially from the upstream side to the downstream side in the conveyance direction H are three conveyance rollers 141, 142, 143. Disposed at respective positions opposite the conveyance rollers 141, 142, 143 are driven rollers 151, 152, 153 that rotate following rotation of the conveyance rollers 141, 142, 143. The conveyed roll paper RH is held between the conveyance rollers 141, 142, 143 and driven rollers 151, 152, 153, and conveyed in the conveyance direction H according to rotation of the conveyance rollers 141, 142, 143. The conveyance rollers 141, 142, 143 are connected to a conveyance motor through a power transfer mechanism, and turn as driven by the conveyance motor.

As shown in FIG. 1, a guide member 17 is disposed between conveyance roller 141, which is located farthest upstream in the conveyance direction H, and the conveyance roller 142 located next downstream from the conveyance roller 141. The guide member 17 contacts the back side of the conveyed roll paper RH, and causes the conveyed roll paper RH conveyed up from the paper compartment 11 to curve toward the front of the printer 1. By contacting and causing the conveyed roll paper RH to curve, the guide member 17 applies tension to the conveyed roll paper RH, and suppresses the development of slack in the conveyed roll paper RH.

Conveyance roller 143 is disposed downstream in the conveyance direction H from the guide member 17 and conveyance roller 142, and downstream from the conveyance roller 143 is a printing mechanism 19.

The printer 1 includes a printing mechanism 19 that is configured to print on the roll paper R and includes a carriage 20, and an inkjet head 10 mounted on the carriage 20.

The carriage 20 is supported on a carriage rail 20a extending in the scanning direction perpendicular to the conveyance direction H, and moves the inkjet head 10 in the scanning direction along the carriage rail 20a.

The inkjet head 10 in this example is an inkjet head with nozzle rows for multiple colors of ink, such as the four colors cyan (C), yellow (Y), magenta (M), black (K). The inkjet head 10 prints by ejecting ink supplied from ink cartridges not shown from nozzles formed in nozzle rows, forming dots on the conveyed roll paper RH.

The inkjet head and other elements used for printing on the roll paper R embody a printing mechanism.

Downstream in the conveyance direction H from the printing mechanism 19 is a paper cutter 21. The paper cutter 21 includes a fixed knife 22, and a movable knife 23 that can move in a cutting action with the fixed knife 22. The paper cutter 21 moves the movable knife 23 to cut the conveyed roll paper RH.

Downstream in the conveyance direction H from the paper cutter 21 is the paper exit 24. The conveyed roll paper RH is discharged to the outside from the case 2 of the printer 1 through the paper exit 24.

At the side 2a of the case 2 is a cover 25. The cover 25 can pivot on a pin 25a between an open position and a closed position. When the cover 25 is open, the paper compartment 11 disposed inside the case 2 is exposed.

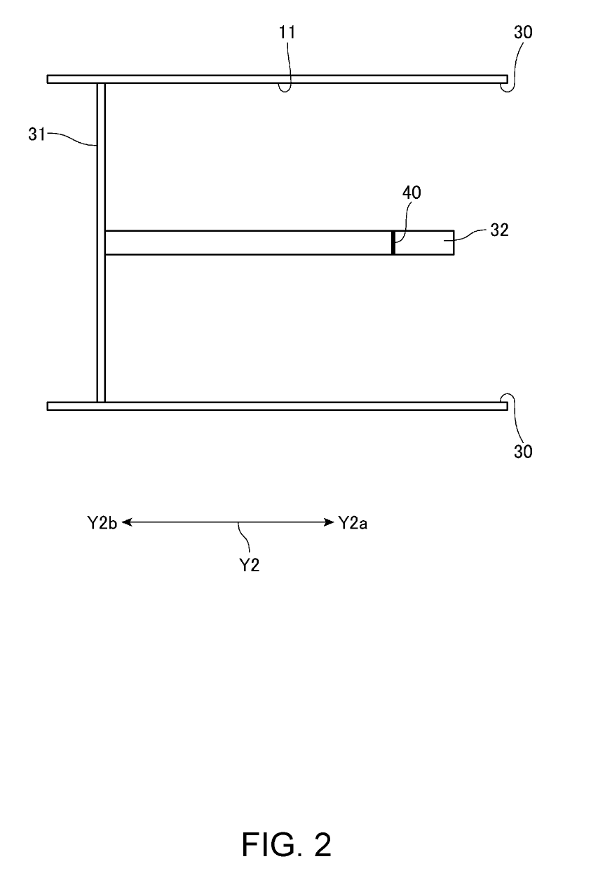

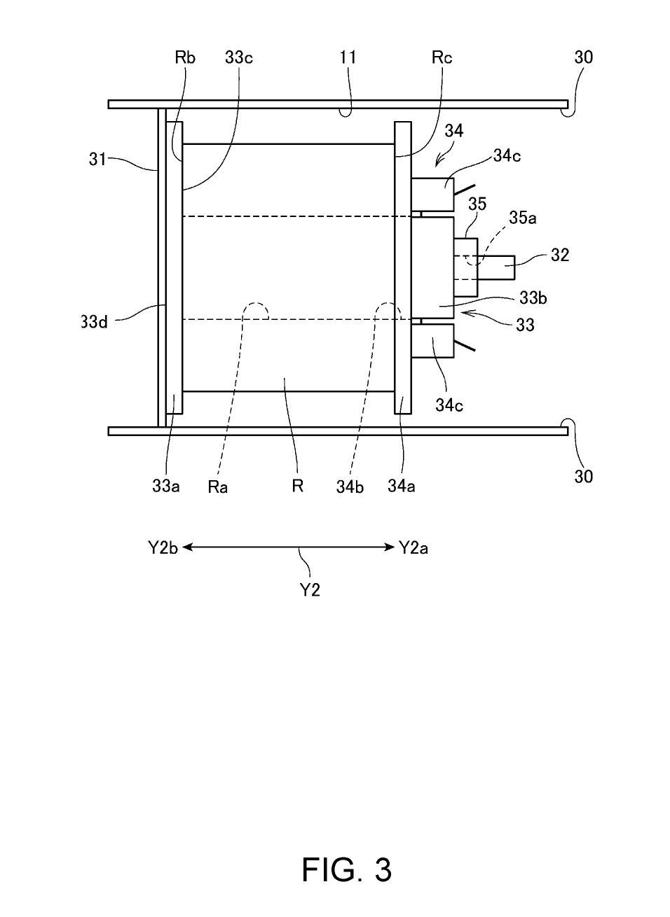

FIG. 2 and FIG. 3 schematically illustrate the paper compartment 11 as seen in the direction of arrow Y1 in FIG. 1, that is, from the front to the back of the printer 1. FIG. 2 shows the paper compartment 11 when the roll paper R is not in the paper compartment 11. FIG. 3 shows the paper compartment 11 when the roll paper R is loaded in the paper compartment 11.

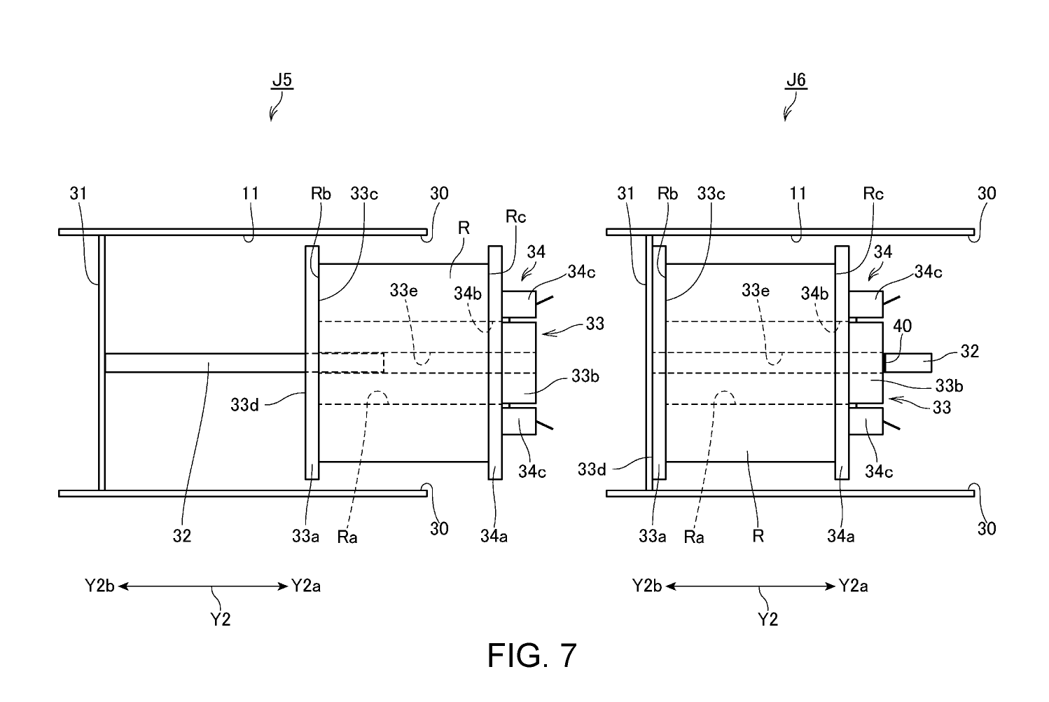

Below, when the roll paper R is stored in the paper compartment 11 as shown in FIG. 3, the direction through the core Ra of the roll paper R is referred to as the axial direction Y2. The axial direction Y2 corresponds to the direction across the width of the roll paper R stored in the paper compartment 11. In FIG. 2, FIG. 3, and FIG. 7, the direction to the right along the axial direction Y2 is referred to as right Y2a, and the direction to the left is referred to as left Y2b.

As shown in FIG. 2 and FIG. 3, the paper compartment 11 is a space large enough to accommodate roll paper R of the largest size that can be used in the printer 1. The paper compartment has an opening 30 formed at the right end of the paper compartment 11. More specifically, the opening 30 is positioned along one side (i.e., the second axial end Rc of the roll paper R toward the right Y2a) along the axial direction Y2 of the roll paper R when the roll paper R is held in the paper compartment 11. When the cover 25 opens, the paper compartment 11 is exposed through the opening 30, and the paper compartment 11 can be accessed.

As shown in FIG. 2, and FIG. 3, the paper compartment 11 has a wall 31 that is formed at the left end of the paper compartment 11. More specifically, the wall 31 is positioned closer to the first axial end Rb of the roll paper R than the second axial end Rc of the roll paper R (i.e., toward the left Y2b) along the axial direction Y2 of the roll paper R when the roll paper R is held in the paper compartment 11.

As shown in FIG. 2, the paper compartment 11 has a rod-shaped spindle 32 that projects in the axial direction Y2 from the center of the wall 31. The spindle 32 extends along the axial direction Y2 of the roll paper R that is held in the paper compartment 11. The function of the spindle 32 is described below.

As shown in FIG. 3, the printer 1 has a paper loading member 33 that is installed within the paper compartment 11 when the roll paper R is installed in the paper compartment 11, and the roll paper R, a paper stop 34, and a roll support member stop 35 are installed on the paper loading member 33. The relative positions of these members, and their shapes and functions, are described below.

The position (referred to below as the specified position) in the printer 1 to which the roll paper R should be installed in the axial direction Y2 of the paper compartment 11 is predefined, and when the roll paper R is set to the specified position, the roll paper R can be conveyed normally and the roll paper R printed on. When the user loads roll paper R into the paper compartment 11, enabling the user to easily and reliably set the roll paper R to the specified position, and thereby improve user convenience, has been desired. More specifically, the printer 1 according to this embodiment has a cover 25 on the side 2a of the case 2, the opening 30 to the paper compartment 11 is shaped according to the side 2a of the case 2 of the printer 1, and the user thus loads the roll paper R from the side of the case 2.

With a printer 1 in which the roll paper R is loaded from the side of the case 2, it is therefore difficult for the user to confirm the position of the roll paper R in the axial direction Y2 inside the paper compartment 11. As a result, a configuration enabling the user to easily and reliably position the roll paper R to the specified position when loading roll paper R into the paper compartment 11 has been strongly desired.

As described above, the printer 1 according to this embodiment also enables installing large format paper as the roll paper R. Because large format paper is large in size and heavy, the task of installing the roll paper R in the paper compartment 11 tends to be difficult. A configuration enabling the user to easily install the roll paper R when loading roll paper R into the paper compartment 11 is therefore also desired for this reason.

To address these problems, the printer 1 according to this embodiment is constructed as described below.

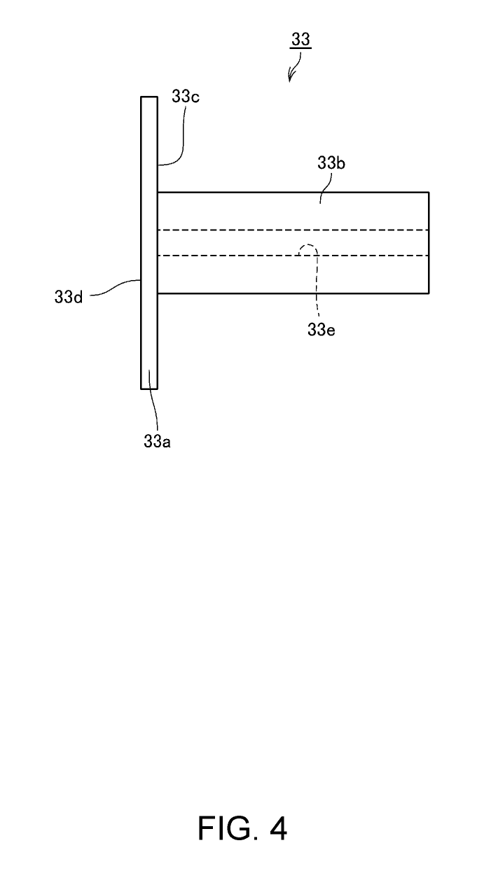

FIG. 4 shows the paper loading member 33.

The paper loading member 33 is configured to be removably installed in the paper compartment 11 through the opening 30 and is used to store the roll paper R in the paper compartment 11. As will be understood below, when the roll paper R is installed in the paper compartment 11, the roll paper R is first installed on the paper loading member 33 outside the case 2, and the paper loading member 33 with roll paper R installed thereon is installed in the paper compartment 11.

As shown in FIG. 4, the paper loading member 33 has a flange 33a and a rod-shaped roll support member 33b protruding from the center of the flange 33a. When seen from the axial direction Y2, the flange 33a is shaped like a disk. The shape of the surface of the flange 33a corresponds to the shape of the surface of the wall 31.

As shown in FIG. 4, the roll support member 33b has a through-hole 33e that passes through the roll support member 33b in the lengthwise direction of the roll support member 33b is disposed in the roll support member 33b. The function of the through-hole 33e is described below. Note that the lengthwise direction of the roll support member 33b is the direction in which the roll support member 33b extends from the flange 33a, and corresponds to the axial direction Y2 of the roll paper R installed in the paper compartment 11.

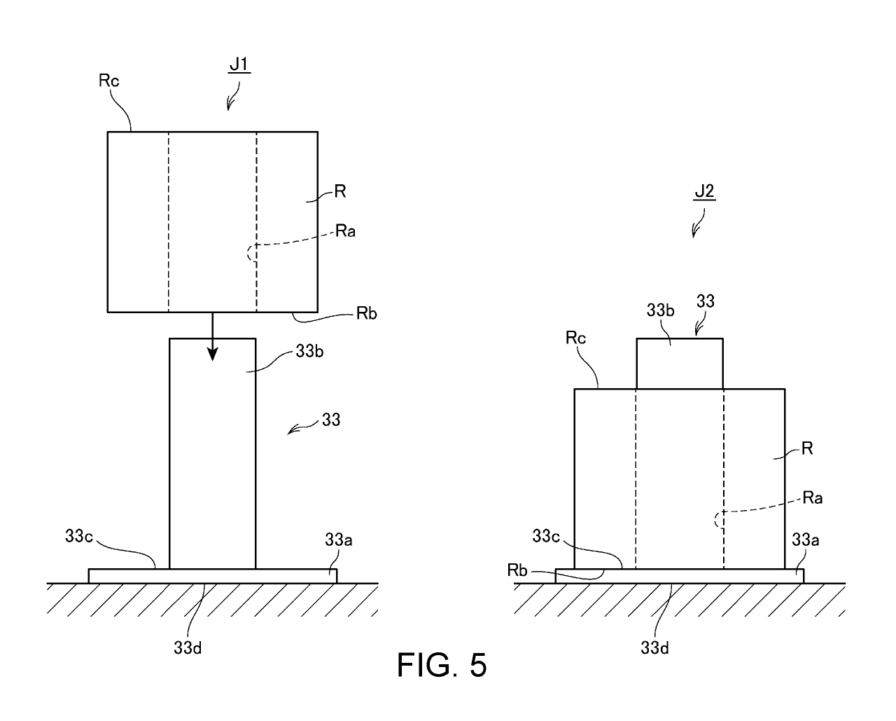

FIG. 5 is used to describe the task of installing the roll paper R to the paper loading member 33. The roll paper R extends axially between a first axial end Rb and a second axial end Rc.

To install the roll paper R to the paper compartment 11, the user first removes the paper loading member 33 from the case 2, and sets the paper loading member 33 with the flange 33a down on a work table or other surface.

State J1 and state J2 in FIG. 5 show the paper loading member 33 sitting on a work surface. As shown in FIG. 5, the paper loading member 33 rests stably on the work surface when the roll support member 33b is upright.

After placing the roll support member 33b on the work surface, the user then installs the roll paper R to the paper loading member 33 (state J1 in FIG. 5) by inserting the roll support member 33b into the core Ra of the roll paper R. When the roll paper R is installed on the paper loading member 33, the user sets the first axial end Rb, which is one end of the roll paper R, against the first flange side 33c, which is a first side of the flange 33a. State J2 in FIG. 5 shows the first axial end Rb of the roll paper R in contact with the first flange side 33c.

As described above, when the paper loading member 33 is set on the work surface, the roll support member 33b stands vertically. As a result, after inserting the distal end of the roll support member 33b into the core Ra of the roll paper R, the user can push the roll paper R down until the first axial end Rb touches the first flange side 33c, using the force of gravity on the roll paper R. The user can therefore easily install the roll paper R to the paper loading member 33 with little effort.

Below, the first axial end Rb being in contact with the first flange side 33c is also referred to as the “contact position.”

The maximum outside circumference of the roll support member 33b corresponds to the size of the inside circumference of the core Ra of the roll paper R. Therefore, when the core Ra is placed onto the roll support member 33b and in the contact position, the outside circumference of the roll support member 33b is in contact with the full inside circumference of the core Ra of the roll paper R, and the roll paper R is held by friction on the roll support member 33b. Note that a configuration in which an intervening member is disposed to the outside circumference of the roll support member 33b, and the roll support member 33b supports the roll paper R through the intervening member, is also conceivable.

The length in the lengthwise direction of the roll support member 33b is greater than the maximum width of the roll paper R than can be stored or installed in the paper compartment 11. As a result, as shown in state J2 in FIG. 5, when in the contact position, the roll support member 33b extends past the second axial end Rc (other end), which is the opposite end (side) of the roll paper R as the first axial end Rb. As a result, support of the roll paper R by the roll support member 33b is stable.

After installing the roll paper R to the paper loading member 33, the user installs the paper stop 34 to the roll support member 33b of the paper loading member 33.

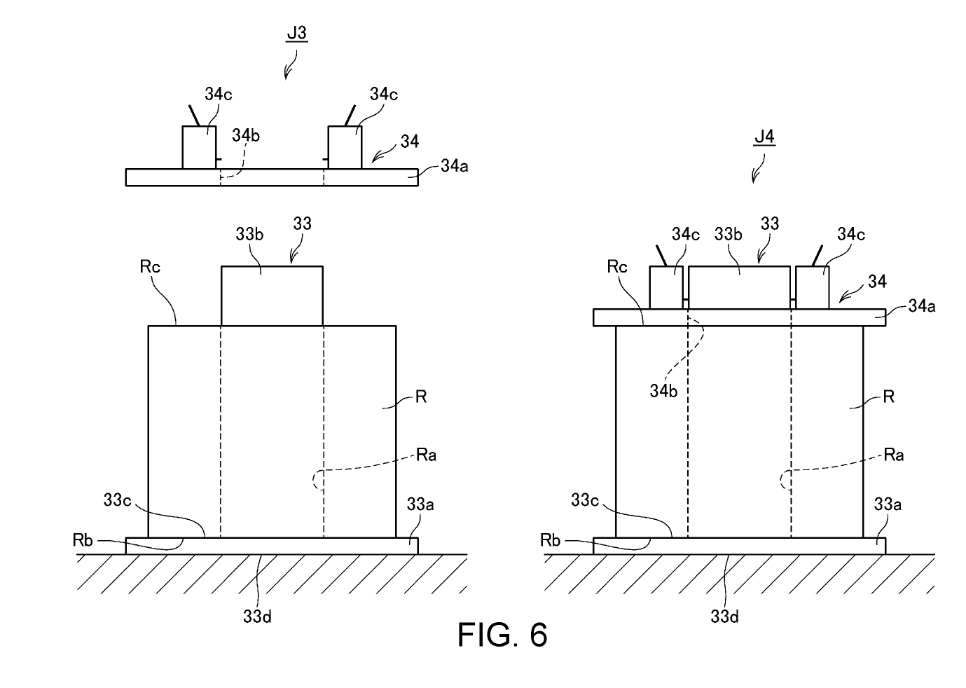

FIG. 6 describes the operation when installing the paper stop 34 to the roll support member 33b.

The paper stop 34 is a member that restricts the position (or movement) of the roll paper R on (or along) the roll support member 33b. The paper stop 34 has a round base 34a. In the center of the base 34a is an insertion hole 34b with an inside circumference of a size corresponding to the size of the outside circumference of the roll support member 33b. Clamps 34c for securing the paper stop 34 to the roll support member 33b are disposed around the insertion hole 34b.

As shown by state J3 and state J4 in FIG. 6, when installing the paper stop 34 to the roll support member 33b, the user moves the paper stop 34 with the roll support member 33b inserted into the insertion hole 34b to the roll paper R side until the one side of the base 34a of the paper stop 34 contacts the second axial end Rc of the roll paper R (the position indicated by state J4 in FIG. 6). When the one side of the base 34a of the paper stop 34 contacts the second axial end Rc of the roll paper R, the paper stop 34 is fastened to the roll support member 33b by the specific mechanism of the clamps 34c. By securing the paper stop 34 to the roll support member 33b, the roll paper R is held between the flange 33a and paper stop 34, and the position of the roll paper R on the roll support member 33b is thereby restricted.

After installing the paper stop 34 to the roll support member 33b, the user opens the cover 25 to expose the paper compartment 11, and installs the paper loading member 33 in the paper compartment 11.

FIG. 7 describes the task of installing the paper loading member 33 in the paper compartment 11.

As indicated by state J5 and state J6 in FIG. 7, to install the paper loading member 33 in the paper compartment 11, the user moves the paper loading member 33 (with the spindle 32 inserted into the through-hole 33e) to the wall 31 side (left Y2b side) until the second flange side 33d (i.e., the second side of the flange 33a), which is the opposite side of the flange 33a as the first flange side 33c, contacts the wall 31 (state J6 shown in FIG. 7). The second flange side 33d of the flange 33a faces the wall 31 of the paper compartment 11.

More specifically, after inserting the distal end of the spindle 32 into the through-hole 33e of the roll support member 33b (state J5 in FIG. 7), the user pushes the paper loading member 33 to the left. Because the paper loading member 33 is supported by the spindle 32 while being pushed to the left, the load on the user is small and the user can easily push the paper loading member 33 even when the size of the roll paper R is large and the roll paper R is heavy. As the paper loading member 33 is pushed, the second flange side 33d contacts the wall 31 (state J6 in FIG. 7), and the paper loading member 33 cannot be pushed further to the left Y2b side. Pushing the paper loading member 33 into place ends when the paper loading member 33 no longer moves when pushed by the user.

When the second flange side 33d is touching the wall 31 is referred to below as the installed state.

When the paper loading member 33 is in the installed state, the first flange side 33c of the flange 33a is on the opening 30 side.

When the roll paper R is installed on the paper loading member 33 and the paper loading member 33 is in the installed state, the roll paper R is in the specified position.

In this embodiment, the user can reliably position the roll paper R to the specified position by the simple operation of inserting the spindle 32 into the through-hole 33e of the roll support member 33b, and then pushing the paper loading member 33 until the paper loading member 33 no longer moves when pushed by the user.

In the installed position, the spindle 32 supports the roll support member 33b. The length of the spindle 32 is greater than the length of the roll support member 33b. As a result, when the paper loading member 33 is in the installed position as shown in state J6 in FIG. 7, the end of the spindle 32 on the opening 30 side is closer to the opening 30 side than the end of the roll support member 33b on the opening 30 side. As a result, in the installed position, support of the roll support member 33b by the spindle 32 is stable.

A index mark 40 (for example, a marking) is disposed to the spindle 32. As shown in state J6 in FIG. 7, the index mark 40 is disposed to the spindle 32 at a position corresponding to the position on the opening 30 side end of the roll support member 33b in the installed position. The user can reliably know if the roll paper R is in the installed position by checking the position of the opening 30 side end of the roll support member 33b relative to the index mark 40.

In this embodiment, the second flange side 33d directly contacts the wall 31 in the installed position. In this respect, a configuration that disposes an intervening member on the wall 31, and the position of the paper loading member 33 in the paper compartment 11 is restricted by contact by the second flange side 33d with the intervening member, is also conceivable.

After installing the paper loading member 33 in the paper compartment 11, the user installs the roll support member stop 35 (see FIG. 3) to the spindle 32.

The roll support member stop 35 is a member that is configured to restrict the position of the roll support member 33b on the spindle 32. The roll support member stop 35 has a through-hole 35a with an inside circumference of a size corresponding to the size of the outside circumference of the spindle 32.

As shown in FIG. 3, when installing the roll support member stop 35 to the spindle 32, the user moves the roll support member stop 35 with the spindle 32 inserted into the through-hole 35a thereof to the wall 31 side (left Y2b side) until the one side of the roll support member stop 35 contacts the opening 30 side end of the roll support member 33b. When one side of the roll support member stop 35 is in contact with the opening 30 side end of the roll support member 33b, the roll support member stop 35 is fastened to the spindle 32 by the specific mechanism of the roll support member stop 35. By fastening the roll support member stop 35 to the spindle 32, the paper loading member 33 is held between the wall 31 and the roll support member stop 35, and the position or any movement of the roll support member 33b on the spindle 32 is thereby restricted along the spindle 32.

As described above, the printer 1 (i.e., the paper conveyance device) has an opening 30 enabling a roll paper R (i.e., a paper roll) to be stored and positioned along one end of the axial direction Y2 of the roll paper R when stored, and a paper compartment 11 having a wall 31 on the other end of the axial direction Y2 of the roll paper R when stored. The printer 1 also has a paper loading member 33 that can be installed in and removed from the paper compartment 11 through the opening 30. The paper loading member 33 has a flange 33a and a roll support member 33b that protrudes from the flange 33a and is configured to be inserted into the core Ra of the roll paper R.

When the roll paper R is installed or stored in the paper compartment 11, the paper loading member 33 is installed in the paper compartment 11 with the first flange side 33c (one side) of the flange 33a in contact with the first axial end Rb (one side) of the roll paper R, and the roll support member 33b is inserted into the core Ra of the roll paper R.

When the paper loading member 33 is installed in the paper compartment 11, the first flange side 33c of the flange 33a of the paper loading member 33 is the side of the flange 33a that is closer to or faces the opening 30 of the paper compartment 11. Thus comprised, the roll paper R can be installed in the paper compartment 11 by the simple task of putting the roll paper R on the roll support member 33b of the paper loading member 33 so that the first axial end Rb contacts the first flange side 33c, and then installing the paper loading member 33 through the opening 30 into the paper compartment 11.

Even when the paper loading member 33 is installed in the paper compartment 11, the user can remove and install roll paper R to the paper loading member 33, and the paper can be installed appropriately to the training of the user.

In this embodiment, the length of the roll support member 33b is greater than the length of the roll paper R of the greatest width that can be held in the paper compartment 11. Thus comprised, the roll support member 33b can stably support the roll paper R.

The roll support member 33b in this embodiment has a through-hole 33e passing lengthwise through the roll support member 33b. The paper compartment 11 has a spindle 32 that protrudes in the axial direction Y2 of the roll paper R when installed in the paper compartment 11. When the paper loading member 33 is installed in the paper compartment 11, the spindle 32 is inserted into the through-hole 33e of the roll support member 33b. Thus comprised, the paper loading member 33 can be installed in the paper compartment 11 by the simple task of inserting the spindle 32 into the second flange side 33d of the roll support member 33b.

In this example, the length of the spindle 32 is greater than the length of the roll support member 33b, and when the paper loading member 33 is installed in the paper compartment 11, the opening-side end of the spindle 32 of the paper compartment 11 is closer to the opening 30 of the paper compartment 11 than the opening-side end of the roll support member 33b of the paper loading member 33. The spindle 32 extends axially between a first end and a second end, where the second end is the opening-side end of the spindle 32 and is closer to the opening 30 than the first end of the spindle 32. The roll support member 33b extends axially between a first end and a second end, where the second end is the opening-side end of the roll support member 33b and is closer to the opening 30 than the first end of the roll support member 33b (when the paper loading member 33 is installed in the paper compartment 11). Thus comprised, the roll support member 33b can be stably supported by the spindle 32.

The spindle 32 in this example has a marking (for example, the index mark 40) indicating the position of the opening-side end of the roll support member 33b. Thus comprised, using the marking on the spindle 32, the user can determine whether or not the roll support member 33b is positioned appropriately on the spindle 32.

The printer 1 according to this embodiment also has a roll support member stop 35, which is configured to be installed on the spindle 32 to which the paper loading member 33 is installed and restrict the position of the roll support member 33b on the spindle 32. Thus comprised, the position of the roll support member 33b on the spindle 32 can be appropriately limited by the roll support member stop 35.

The printer 1 according to this embodiment also has a paper stop 34 that is configured to be installed on the roll support member 33b when the first axial end Rb of the roll paper R is in contact with the first flange side 33c of the flange 33a and the roll support member 33b is inserted into the core Ra of the roll paper R, contact the second axial end Rc (other end) of the roll paper R installed on the roll support member 33b, and restrict the position of the roll paper R on the roll support member 33b. This configuration enables appropriately controlling, with the paper stop 34, the position of the roll paper R on the roll support member 33b.

The invention is described above with reference to a preferred embodiment thereof, but the invention is not limited thereto and can be modified and adapted in many ways without departing from the scope of the accompanying claims.

For example, the paper conveyance device and printing device in the foregoing embodiment are used with an inkjet printer. However, the paper conveyance device and printing device are not limited to use with an inkjet printer. For example, the paper conveyance device and printing device can be widely deployed in devices that can store and process paper (media) in a roll. For example, the paper conveyance device and printing device can be used with devices that print to small format paper, such as receipt printers, scanners that optically read stored paper, and other devices.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A paper conveyance device comprising:
a paper compartment configured to hold roll paper that extends between a first axial end and a second axial end, the paper compartment having an opening positioned along the second axial end of the roll paper when the roll paper is held in the paper compartment;
a paper loading member configured to be removably installed in the paper compartment through the opening,
the paper loading member including a flange and a roll support member that protrudes from the flange and is configured to be inserted into the paper;
wherein, when the roll paper is held in the paper compartment, the paper loading member is installed in the paper compartment with a first side of the flange contacting the first axial end of the roll paper, and the roll support member is inserted into the roll paper; and
wherein, when the paper loading member is installed in the paper compartment, the first side of the flange of the paper loading member faces the opening of the paper compartment.

2. The paper conveyance device described in claim 1, wherein:
the length of the roll support member is greater than the maximum width of the roll paper held in the paper compartment.

3. The paper conveyance device described in claim 1, wherein:
the roll support member has a through-hole passing lengthwise through the roll support member;
the paper compartment has a roll spindle extending along the axial direction of the roll paper held in the paper compartment; and
the roll spindle is inserted into the through-hole of the roll support member when the paper loading member is installed in the paper compartment.

4. The paper conveyance device described in claim 3, wherein:
the length of the roll spindle is greater than the length of the roll support member; and
when the paper loading member is installed in the paper compartment, an opening-side end of the roll spindle of the paper compartment is closer to the opening of the paper compartment than an opening-side end of the roll support member of the paper loading member.

5. The paper conveyance device described in claim 4, wherein:
the roll spindle has a marking indicating a position of the opening-side end of the roll support member.

6. The paper conveyance device described in claim 4, further comprising:
a roll support member stop configured to be installed on the roll spindle to which the paper loading member is installed and restrict the position of the roll support member on the roll spindle.

7. The paper conveyance device described in claim 4, further comprising:
a paper stop configured to be installed to the roll support member when the first axial end of the roll paper is in contact with the one side of the flange and the roll support member is inserted into the roll paper, contact the second axial end of the roll paper installed on the roll support member, and restrict the position of the roll paper on the roll support member.

8. The paper conveyance device described in claim 1, wherein:
the paper compartment has a wall positioned closer to the first axial end of the roll paper than the second axial end of the roll paper when the roll paper is held in the paper compartment.

9. The paper conveyance device described in claim 8, wherein:
when the paper loading member is installed in the paper compartment, a second side of the flange contacts the wall, wherein the second side of the flange faces the wall of the paper compartment.

10. A printing device comprising:
a paper compartment configured to hold roll paper that extends between a first axial end and a second axial end, the paper compartment having an opening positioned along the second axial end of the roll paper when the roll paper is held in the paper compartment and a wall positioned along the first axial end of the roll paper when the roll paper is held in the paper compartment;
a printing mechanism configured to print on the roll paper; and
a paper loading member configured to be removably installed in the paper compartment through the opening,
the paper loading member including a flange and a roll support member that protrudes from the flange and is configured to be inserted into the paper;
wherein, when the roll paper is held in the paper compartment, the paper loading member is installed in the paper compartment with a first side of the flange contacting the first axial end of the roll paper, and the roll support member is inserted into the roll paper; and
wherein, when the paper loading member is installed in the paper compartment, the first side of the flange of the paper loading member is the side of the flange that faces the opening of the paper compartment.
